(19) United States
(12) Patent Application Publication
(10) Pub. No.: US 2017/0255374 A1
(43) Pub. Date: Sep. 7, 2017

(54) MULTI-SCREEN DISPLAY POSITION EXCHANGE METHOD, INFORMATION PROCESSING APPARATUS, AND CONTROL METHOD AND CONTROL PROGRAM OF INFORMATION PROCESSING APPARATUS

(71) Applicant: NEC Corporation, Tokyo (JP)

(72) Inventors: Tatsushi YASUDA, Tokyo (JP); Satoru ISHII, Tokyo (JP); Masato KITADA, Tokyo (JP)

(73) Assignee: NEC Corporation, Tokyo (JP)

(21) Appl. No.: 15/511,873

(22) PCT Filed: Jun. 16, 2015
(86) PCT No.: PCT/JP2015/067301

§ 371 Date: Mar. 16, 2017

(30) Foreign Application Priority Data
Sep. 16, 2014 (JP) 2014-188303

(51) Int. Cl. G06F 3/0484; G06F 3/0488; G06F 3/0486

(52) U.S. Cl. CPC G06F 3/04847; G06F 3/0486; G06F 3/0488; G06F 2203/04803

(57) ABSTRACT

This invention provides an information processing apparatus for exchanging display positions by an operation directly representing a user's intention. The information processing apparatus includes a display unit that displays at least two screens, a stroke detector that detects, in regions of different screens, strokes toward another screen, and an exchanger that exchanges the different screens if the stroke detector detects the strokes. If the strokes are detected in the regions of the different screens during a common time period, the exchanger exchanges the different screens. Alternatively, if the strokes are detected in the regions of the different screens during different time periods, the exchanger exchanges the different screens.

The present invention relates to a multi-screen display position exchange method, an information processing apparatus, and a control method and a control program of the information processing apparatus.

### BACKGROUND ART

In the above technical field, patent literature 1 discloses a technique of exchanging the display position of a main image and that of a sub image by dragging a finger from the central portion of the main image to that of the sub image on a display screen divided into two parts (see FIG. 14).

### CITATION LIST

### Patent Literature

Patent literature 1: Japanese Patent Laid-Open No. 2007-257220

### SUMMARY OF THE INVENTION

### Technical Problem

In the technique described in the above literature, however, many operation conditions (for example, five determination conditions) are necessary to associate a one-way drag operation with exchange of display positions so as to be isolated from a simple drag operation, which is not a simple operation for the user.

The present invention enables to provide a technique of solving the above-described problem.

### Solution to Problem

One aspect of the present invention provides an information processing apparatus comprising:
a display unit that displays at least two screens;
a stroke detector that detects, in regions of different screens, strokes toward another screen; and
an exchanger that exchanges the different screens if the stroke detector detects the strokes.

Another aspect of the present invention provides a method of controlling an information processing apparatus, comprising:
displaying at least two screens;
detecting, in regions of different screens, strokes toward another screen; and
exchanging the different screens if the strokes are detected in the detecting.

Still other aspect of the present invention provides a program of controlling an information processing apparatus, for causing a computer to execute a method, comprising:
displaying at least two screens;
detecting, in regions of different screens, strokes toward another screen; and
exchanging the different screens if the strokes are detected in the detecting.

Still other aspect of the present invention provides a method of exchanging multi-screen display position, comprising:
detecting, in regions of different screens, strokes toward another screen; and
exchanging the different screens if the strokes are detected in the detecting.

### Advantageous Effects of Invention

According to the present invention, it is possible to exchange display positions by an operation directly representing a user's intention.

### BRIEF DESCRIPTION OF DRAWINGS

FIG. 1 is a block diagram showing the arrangement of an information processing apparatus according to the first embodiment of the present invention;

FIG. 2A is a view showing a screen exchange operation of an information processing apparatus according to the second embodiment of the present invention;

FIG. 2B is a view showing another screen exchange operation of the information processing apparatus according to the second embodiment of the present invention;

FIG. 3 is a block diagram showing the functional arrangement of the information processing apparatus according to the second embodiment of the present invention;

FIG. 4 is a view showing the structure of display frame information according to the second embodiment of the present invention;

FIG. 5 is a table showing the structure of an exchange determination table according to the second embodiment of the present invention;

FIG. 6 is a block diagram showing the hardware arrangement of the information processing apparatus according to the second embodiment of the present invention;

FIG. 7 is a flowchart illustrating the processing procedure of the information processing apparatus according to the second embodiment of the present invention;

FIG. 8 is a flowchart illustrating a frame control procedure according to the second embodiment of the present invention;

FIG. 9A is a view showing a screen exchange operation of an information processing apparatus according to the third embodiment of the present invention;

FIG. 9B is a view showing another screen exchange operation of the information processing apparatus according to the third embodiment of the present invention;

FIG. 10 is a table showing the structure of an exchange determination table according to the third embodiment of the present invention;

FIG. 11 is a flowchart illustrating the processing procedure of the information processing apparatus according to the third embodiment of the present invention;

FIG. 12A is a view showing a screen exchange operation of an information processing apparatus according to the fourth embodiment of the present invention;

FIG. 12B is a view showing another screen exchange operation of the information processing apparatus according to the fourth embodiment of the present invention;

FIG. 12C is a view showing still other screen exchange operation of the information processing apparatus according to the fourth embodiment of the present invention;

FIG. 13A is a view showing a screen exchange operation of an information processing apparatus according to the fifth embodiment of the present invention;

FIG. 13B is a view showing another screen exchange operation of the information processing apparatus according to the fifth embodiment of the present invention;

FIG. 14 is a block diagram showing the functional arrangement of the information processing apparatus according to the fifth embodiment of the present invention;

FIG. 15 is a view showing the structure of display frame information according to the fifth embodiment of the present invention;

FIG. 16 is a table showing the structure of a rotation determination table according to the fifth embodiment of the present invention;

FIG. 17 is a flowchart illustrating the processing procedure of the information processing apparatus according to the fifth embodiment of the present invention;

FIG. 18 is a flowchart illustrating a display frame control procedure according to the fifth embodiment of the present invention; and

FIG. 19 is a view showing a screen exchange operation of an information processing apparatus according to the sixth embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

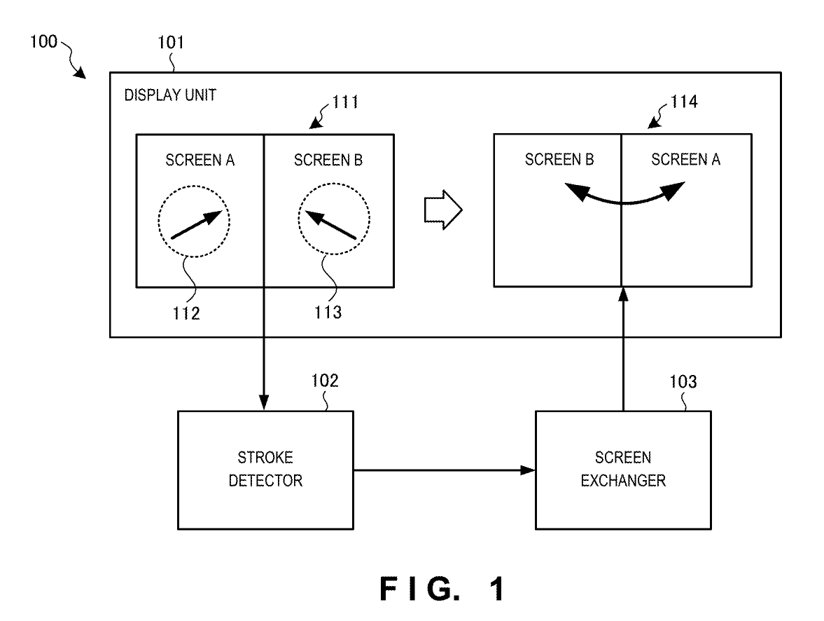

An information processing apparatus 100 according to the first embodiment of the present invention will be described with reference to FIG. 1. The information processing apparatus 100 is an apparatus for displaying at least two screens.

As shown in FIG. 1, the information processing apparatus 100 includes a display unit 101, a stroke detector 102, and a screen exchanger 103. The display unit 101 displays at least two screens A and B (see a full screen 111). The stroke detector 102 detects, in regions of different screens A and B, strokes 112 and 113 toward another screen. If the stroke detector 102 detects the strokes 112 and 113, the screen exchanger 103 exchanges different screens A and B (see a full screen 114).

According to this embodiment, upon detecting, in the regions of different screens, strokes toward another screen, the screens are exchanged. Thus, it is possible to exchange display positions by an operation directly representing a user's intention. That is, there is provided a method of exchanging display positions of multi-screen by an intuitive user operation.

### Second Embodiment

An information processing apparatus according to the second embodiment of the present invention will be described next. Upon detecting, in each of different screens, a stroke toward the other screen by two fingers of both hands or one hand, the information processing apparatus according to this embodiment exchanges the screens. Note that the following example will describe a case in which the time periods of the strokes overlap each other. However, even if the time periods of the strokes do not overlap each other, it is possible to exchange the screens.

<<Screen Exchange Operation>>

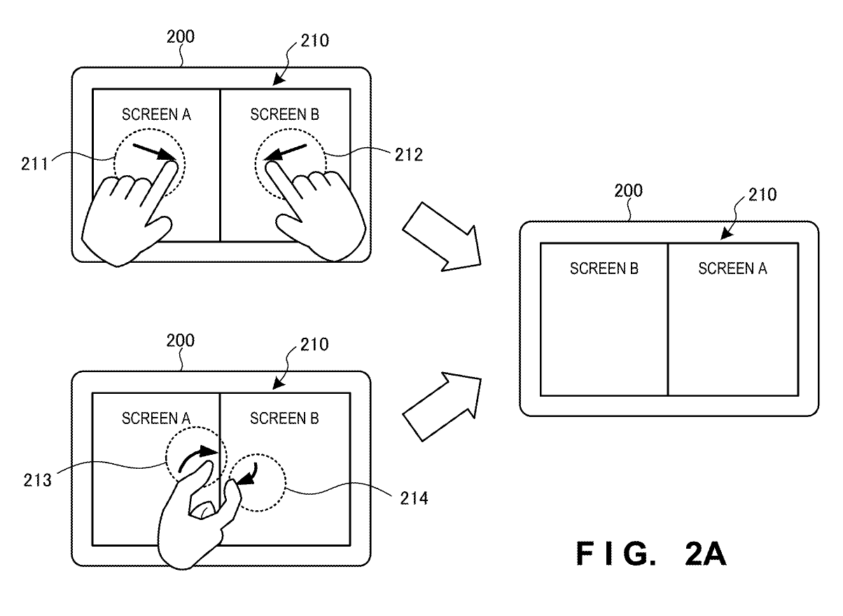

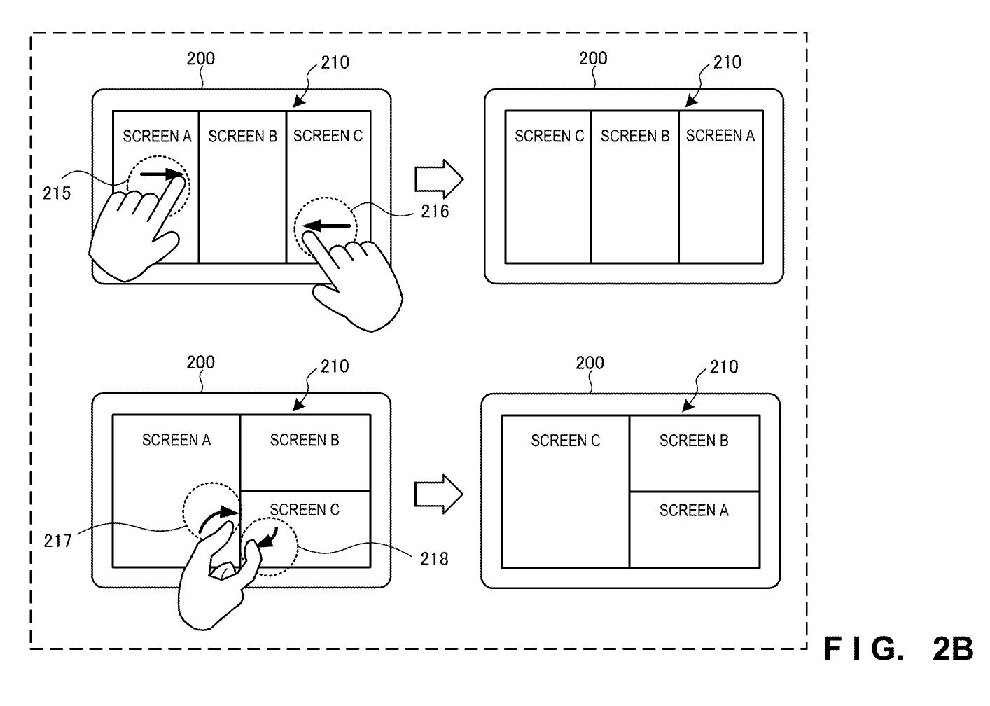

FIG. 2A is a view showing a screen exchange operation of an information processing apparatus 200 according to this embodiment. FIG. 2A shows an example in which two screens are divisionally displayed. FIG. 2A shows, from left, a screen exchange operation by two fingers and a screen exchange result.

Screens A and B are divisionally displayed on a display screen 210 of the information processing apparatus 200. When the user draws a stroke 211 toward screen B on screen A by a finger of the left hand, and draws a stroke 212 toward screen A on screen B by a finger of the right hand, screens A and B are exchanged (see the right view). Alternatively, when the user draws a stroke 213 toward screen B on screen A and a stroke 214 toward screen A on screen B by two fingers of the left hand (or two fingers of the right hand), screens A and B are exchanged (see the right view). This operation is an intuitive operation representing that the user is intended to exchange the screens. Therefore, it is possible to exchange the display positions by the operation directly representing the user's intention.

FIG. 2B is a view showing another screen exchange operation of the information processing apparatus 200 according to this embodiment. FIG. 2B shows an example in which three screens are divisionally displayed. FIG. 2B shows, from left, a screen exchange operation by two fingers and a screen exchange result.

Screens A, B, and C are divisionally displayed on the display screen 210 of the information processing apparatus 200. When the user draws a stroke 215 toward screen C on screen A by a finger of the left hand, and draws a stroke 216 toward screen A on screen C by a finger of the right hand, screens A and C are exchanged (see the right view). Alternatively, when the user draws a stroke 217 toward screen C on screen A and a stroke 218 toward screen A on screen C by two fingers of the left hand (or two fingers of the right hand), screens A and C are exchanged (see the right view). This operation is an intuitive operation representing that the user is intended to exchange the screens. Therefore, it is possible to exchange the display positions by the operation directly representing the user's intention.

Note that a stroke according to this embodiment is desirably drawn by a flick operation like a light flip by a fingertip but may be drawn by a swipe operation of sliding a fingertip.

<<Functional Arrangement of Information Processing Apparatus>>

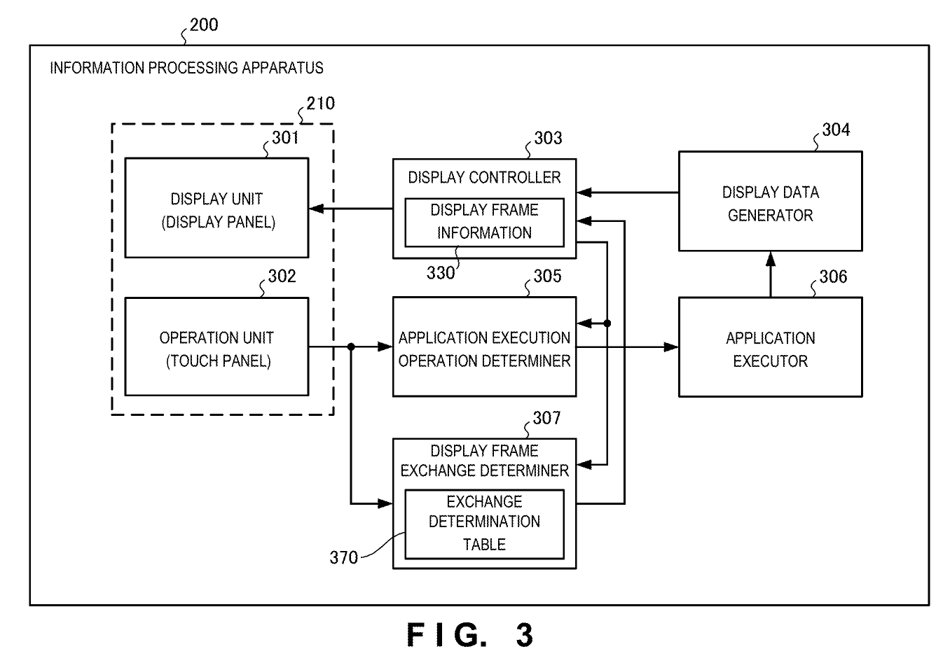

FIG. 3 is a block diagram showing the functional arrangement of the information processing apparatus 200 according to this embodiment.

The information processing apparatus 200 includes a display unit 301 with a display panel, and an operation unit 302 with a touch panel, a home button, and the like. Among them, the display panel and the touch panel form the display screen 210. The information processing apparatus 200 includes a display controller 303, a display data generator 304, an application execution operation determiner 305, and an application executor 306.

The application execution operation determiner 305 determines an application execution operation in the operation unit 302. In the case of the application execution operation, the application executor 306 activates an application, and executes it. The display data generator 304 generates display data according to the executed application. The display controller 303 has display frame information 330, assigns, to a display frame, the display data generated by executing the application, and displays the display data on the display unit 301, thereby implementing screen control.

Furthermore, the information processing apparatus 200 includes a display frame exchange determiner 307. The display frame exchange determiner 307 has an exchange determination table 370, and determines screen exchange based on an operation in the operation unit 302. If the display frame exchange determiner 307 determines screen exchange, the display controller 303 exchanges screens by changing the display frame information 330.

(Display Frame Information)

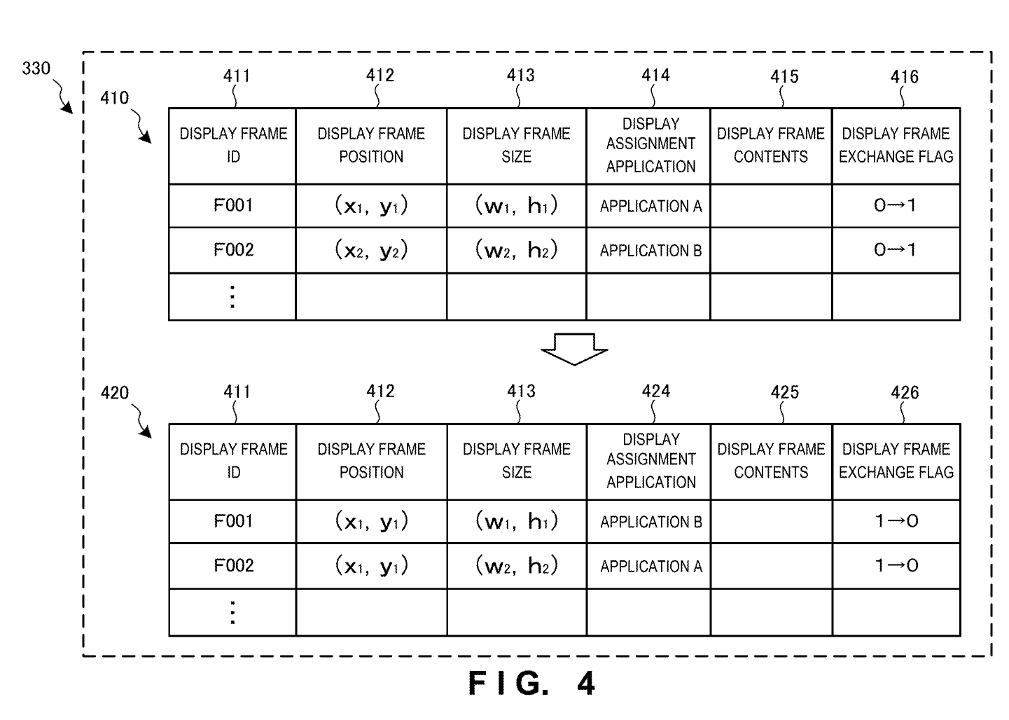

FIG. 4 is a view showing the structure of the display frame information 330 according to this embodiment. The display frame information 330 is used by the display controller 303 to arrange display information related to the application on a screen. FIG. 4 shows an example of exchange between screen A generated by application A and screen B generated by application B. Note that in FIG. 4, for each frame, different numerical values are set also in a frame display position and frame size in the y-axis direction (vertical direction) in order to maintain the generality. However, in the case of the divided screens in the x-axis direction (horizontal direction) shown in FIGS. 2A and 2B, the same values of y and h are set for all display frames.

The upper part of FIG. 4 shows display frame information 410 before exchange. The display frame information 410 stores a display frame position 412 and a display frame size 413 in association with a display frame ID 411. Note that a display position may be the upper left of a display frame but is not limited to this. In addition, instead of the display frame position 412 and the display frame size 413, two display positions of corners of the display frame may be stored.

The display frame information 410 stores, in association with the display frame ID 411, as a display assignment application 414, an application for generating information to be displayed on the display frame. Frame contents 415 generated by the application are stored.

Furthermore, the display frame information 410 stores, for each display frame, a display frame exchange flag 416 based on the screen exchange operation. In this example, by the screen exchange operation, the display frame exchange flag 416 changes from “0” to “1”, thereby executing screen exchange.

The lower part of FIG. 4 shows display frame information 420 after exchange. The display frame information 420 stores the display frame position 412 and the display frame size 413 in association with the display frame ID 411, similarly to the display frame information 410.

The display frame information 420 exchanges the application for generating information to be displayed on the display frame, and stores, as a display assignment application 424, the application in association with the display frame ID 411. Frame contents 425 generated by the application are stored.

Furthermore, the display frame information 420 stores, for each display frame, a display frame exchange flag 426 based on the screen exchange operation. In this example, upon end of the screen exchange operation, the display frame exchange flag 426 changes from “1” to “0”, thereby ending screen exchange.

Note that in FIG. 4, the screens are exchanged by exchanging assignments of the generated data of the applications to the display frames arranged in advance. However, the screens may be exchanged by exchanging the display positions of the display frames without exchanging the assignments.

(Exchange Determination Table)

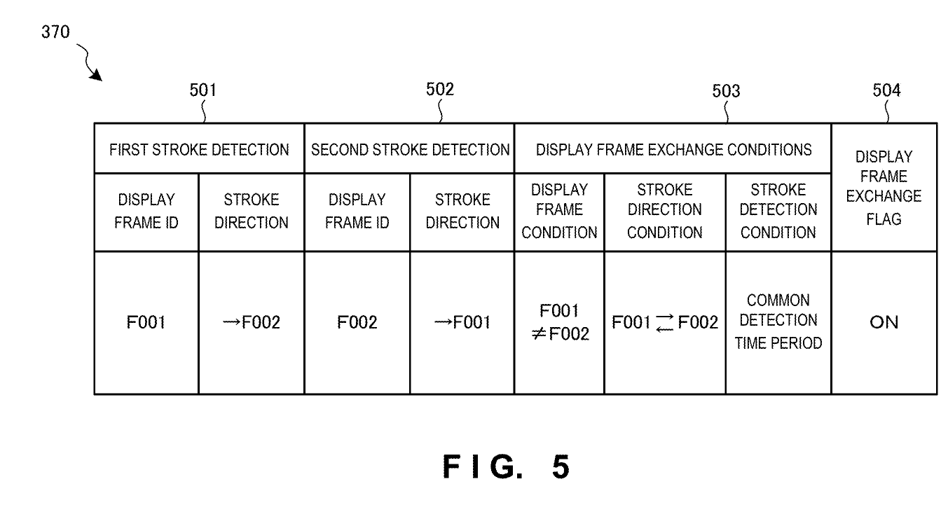

FIG. 5 is a table showing the structure of the exchange determination table 370 according to this embodiment. The exchange determination table 370 stores conditions for setting the display frame exchange flag to “1”, thereby determining that a screen exchange operation has been performed. FIG. 5 shows conditions for determining a screen exchange operation.

The exchange determination table 370 stores first stroke detection 501 and second stroke detection 502 each including a display frame ID and a stroke direction, which have been detected on the screens. The exchange determination table 370 stores conditions 503 for determining a display frame exchange operation. The conditions 503 include a display frame condition, a stroke direction condition, and a stroke detection condition. The display frame condition is a condition that detected first and second strokes are in different display frames. The stroke direction condition is a condition that each of the first and second strokes is oriented to the display frame of the exchange partner. The stroke detection condition is related to the relationship between the detection times of the first and second strokes. In this embodiment, the stroke detection condition is a condition that the time periods overlap each other, that is, the first and second strokes have a common time period. If the screen exchange operation according to this example is performed by two fingers, these conditions are often satisfied.

If all the conditions 503 are satisfied, a display frame exchange flag 504 is turned on (set to “1”) in the exchange determination table 370.

FIG. 5 shows, as a practical example of the case of FIGS. 2A and 2B, a case in which the first stroke in a display frame F001 is oriented to a display frame F002, the second stroke in the display frame F002 is oriented to the display frame F001, and the first and second strokes have a common time period. Then, the display frame exchange flag 504 is turned on (set to “1”).

Under the conditions shown in FIG. 5, it is possible to distinguish the screen exchange operation from a flick operation or swipe operation by starting detection of strokes upon detecting touches within the first time in the regions of different screens. In addition, it is possible to distinguish an exchange instruction from an input instruction or icon instruction and the like by starting detection of strokes when a stroke is started within the second time after touch at a start position. These conditions, however, are not limited to them.

<<Hardware Arrangement of Information Processing Apparatus>>

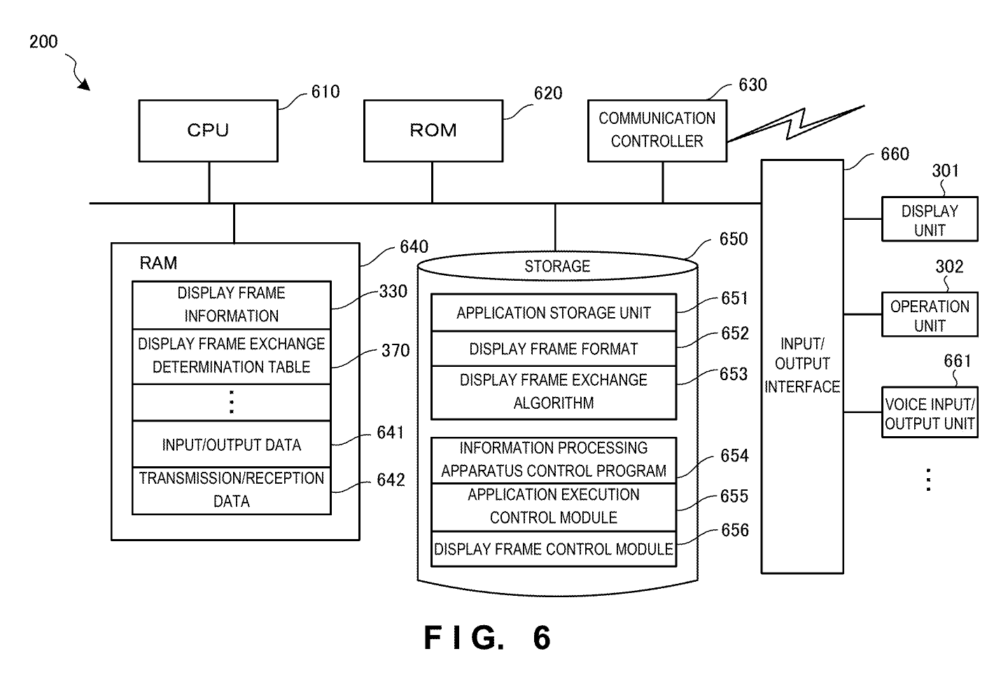

FIG. 6 is a block diagram showing the hardware arrangement of the information processing apparatus 200 according to this embodiment.

Referring to FIG. 6, a CPU (Central Processing Unit) 610 is an arithmetic control processor, and implements the functional components of the information processing apparatus 200 shown in FIG. 3 by executing a program. A ROM (Read Only Memory) 620 stores permanent data such as initial data and a program, and programs. A communication controller 630 communicates with another apparatus via a network. Note that the number of CPUs 610 is not limited to one, and a plurality of CPUs or a GPU (Graphic Processing Unit) for image processing may be included. The communication controller 630 desirably includes a CPU independent of the CPU 610, and writes or reads out transmission/reception data in or from the area of a RAM (Random Access Memory) 640. It is desirable to provide a DMAC (Direct Memory Access Controller) (not shown) for transferring data between the RAM 640 and a storage 650. Furthermore, an input/output interface 660 desirably includes a CPU independent of the CPU 610, and writes or reads out input/output data in or from the area of the RAM 640. Therefore, the CPU 610 processes the data by recognizing that the data has been received by or transferred to the RAM 640. Furthermore, the CPU 610 prepares a processing result in the RAM 640, and delegates succeeding transmission or transfer to the communication controller 630, DMAC, or input/output interface 660.

The RAM 640 is a random access memory used as a temporary storage work area by the CPU 610. An area to store data necessary for implementation of the embodiment is allocated to the RAM 640. The display frame information 330 stores the definition of a display frame including an enlarged display frame to be superimposed and displayed, and the relation with an application. The display frame exchange determination table 370 is a table for determining screen exchange. Input/output data 641 are data transferred to/from the display unit 301 and the operation unit 302 via the input/output interface 660. Transmission/reception data 642 are data transmitted/received via the communication controller 630.

The storage 650 stores a database, various parameters, or the following data or programs necessary for implementation of the embodiment. An application storage unit 651 stores applications executed by the information processing apparatus 200. A display frame format 652 stores the formats of the display frames stored in the display frame information 330. A display frame exchange algorithm 653 stores a screen exchange determination algorithm.

The storage 650 stores the following programs. An information processing apparatus control program 654 is a basic program for controlling the overall information processing apparatus 200. An application execution control module 655 is a module for executing the applications stored in the application storage unit 651. A display frame control module 656 is a module for controlling the arrangement, on the display unit 301, of the display frames assigned with pieces of display information generated by executing the applications and, in this example, controls screen exchange in accordance with the display frame exchange flags.

The input/output interface 660 interfaces input/output data with an input/output device. The input/output interface 660 is connected to the display unit 301, the operation unit 302, a voice input/output unit 661, and the like. A GPS (Global Positioning System) position determiner may also be connected.

Note that programs and data which are associated with the general-purpose functions of the information processing apparatus 200 and other feasible functions are not shown in the RAM 640 or the storage 650 of FIG. 6.

<<Processing Procedure of Information Processing Apparatus>>

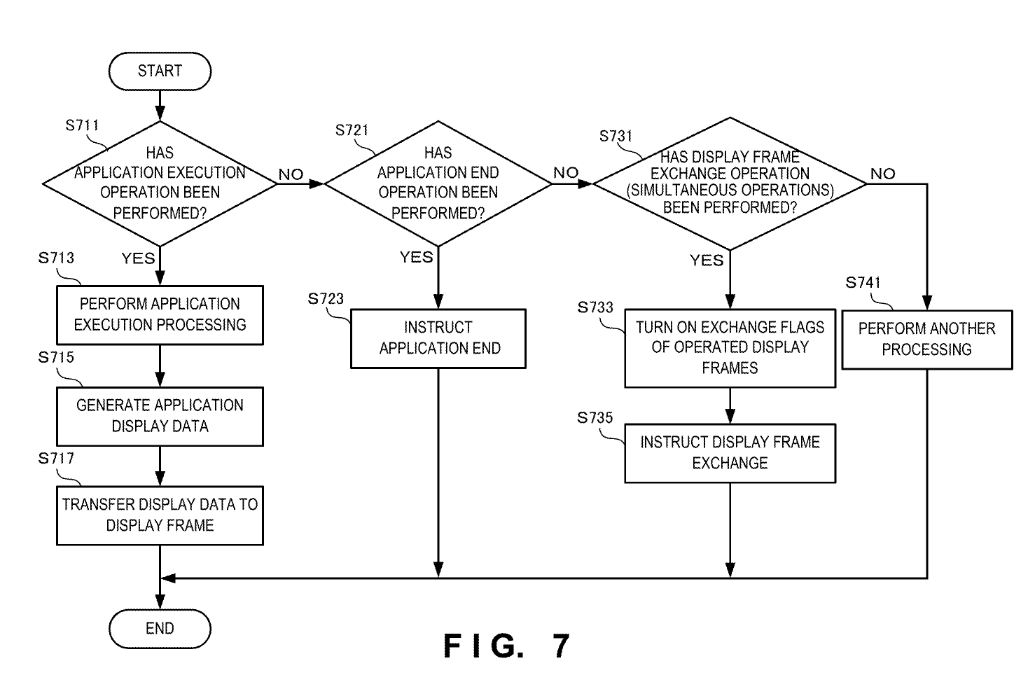

FIG. 7 is a flowchart illustrating the processing procedure of the information processing apparatus 200 according to this embodiment. This flowchart is executed by the CPU 610 of FIG. 6 using the RAM 640, thereby implementing the functional components of FIG. 3.

In step S711, the information processing apparatus 200 determines whether an application execution operation has been performed on a display screen. If an application execution operation has been performed, the information processing apparatus 200 executes an instructed application in step S713. In step S715, the information processing apparatus 200 generates display data related to execution of the application. In step S717, the information processing apparatus 200 transfers the generated display data to display it in an assigned display frame.

If no application execution operation has been performed, the information processing apparatus 200 determines in step S721 whether an operation of ending the currently executed application has been performed. If the operation of ending the currently executed application has been performed, the information processing apparatus 200 instructs end of the currently executed application in step S723.

If neither an application execution operation nor an application end operation has been performed, the information processing apparatus 200 determines in step S731 whether a screen exchange operation has been performed on the screen. In this example, simultaneous operations in which two strokes have a common time period correspond to the screen exchange operation. If it is determined that the screen exchange operation has been performed, the information processing apparatus 200 turns on, in step S733, the display frame exchange flags of the display frames for which the screen exchange operation has been performed, and instructs display frame exchange in step S735.

If none of an application execution operation, an application end operation, and a display frame exchange operation has been performed, the information processing apparatus 200 performs, in step S741, another processing instructed and operated.

(Display Frame Control)

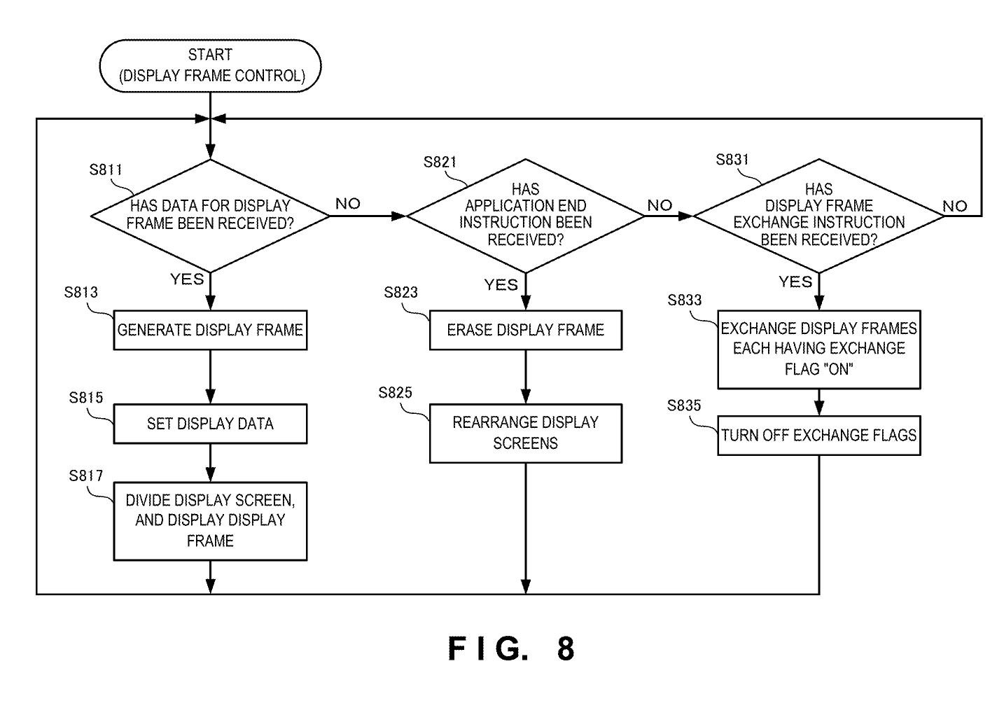

FIG. 8 is a flowchart illustrating a display frame control procedure according to this embodiment.

In step S811, the information processing apparatus 200 determines whether data for a display frame has been received by the processing in step S717 of FIG. 7. If data for a display frame has been received, the information processing apparatus 200 generates a display frame in step S813. Next, in step S815, the information processing apparatus 200 sets the received display data in the generated display frame. In step S817, the information processing apparatus 200 divides the display screen, and displays the display data of the display frame. Not that the procedure of dividing the display screen has been explained in steps S813 to S817 above. If divided screens are generated by a plurality of display frames, the display data is assigned to a display frame in correspondence with the application, and generation of a display frame in step S813 is unnecessary.

If no data for a display frame has been received, the information processing apparatus 200 determines in step S821 whether an application end instruction has been received that had been instructed in step S723 of FIG. 7. If the application end instruction has been received, the information processing apparatus 200 erases, in step S823, the display frame in which the display data is displayed. In step S825, the information processing apparatus 200 rearranges the display screens. Note that if the divided screens are preset, as described above, data are rearranged in the opened display frames, and erase of the display frame in step S823 is unnecessary.

If neither data for a display frame nor an application end instruction has been received, the information processing apparatus 200 determines in step S831 whether a screen exchange instruction has been received by the processing in step S735 of FIG. 7. If the screen exchange instruction has been received, the information processing apparatus 200 executes, in step S833, processing of exchanging two display frames each having the display frame exchange flag “ON”. In step S835, the information processing apparatus 200 turns off the display frame exchange flags of the two display frames, thereby ending the screen exchange processing.

According to this embodiment, different screens are exchanged using two fingers of both hands or one hand by detecting, in each of the regions of the different screens, a stroke toward the other screen. Thus, it is possible to exchange the display positions by the operation directly representing the user's intention.

### Third Embodiment

An information processing apparatus according to the third embodiment of the present invention will be described next. The information processing apparatus according to this embodiment is different from that according to the above-described second embodiment in that different screens are exchanged upon detecting, in each of the screens, a stroke toward the other screen by one finger of one hand. In this embodiment, the time periods of the strokes do not overlap each other. The remaining components and operations are the same as those in the second embodiment. Hence, the same reference numerals denote the same components and operations, and a detailed description thereof will be omitted.

<<Screen Exchange Operation>>

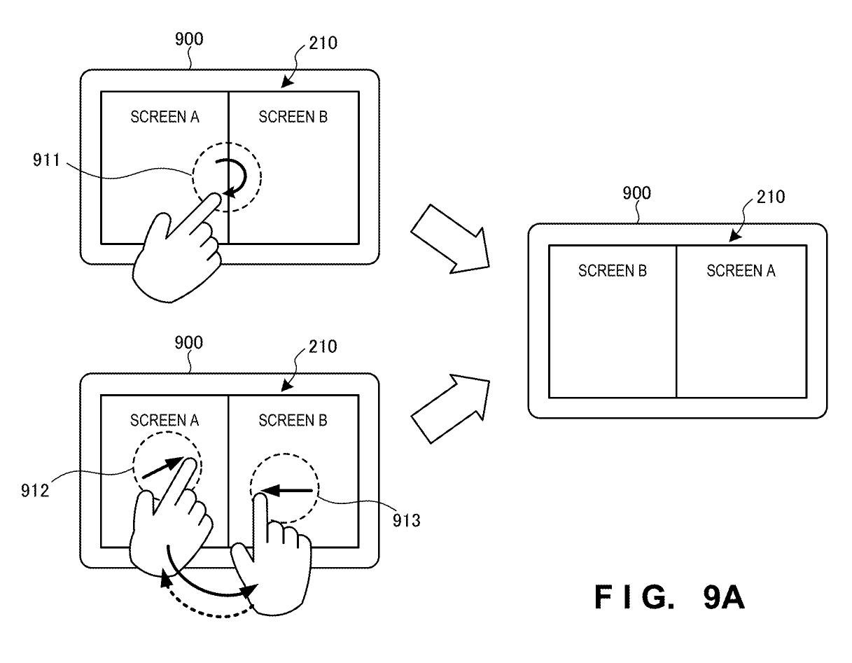

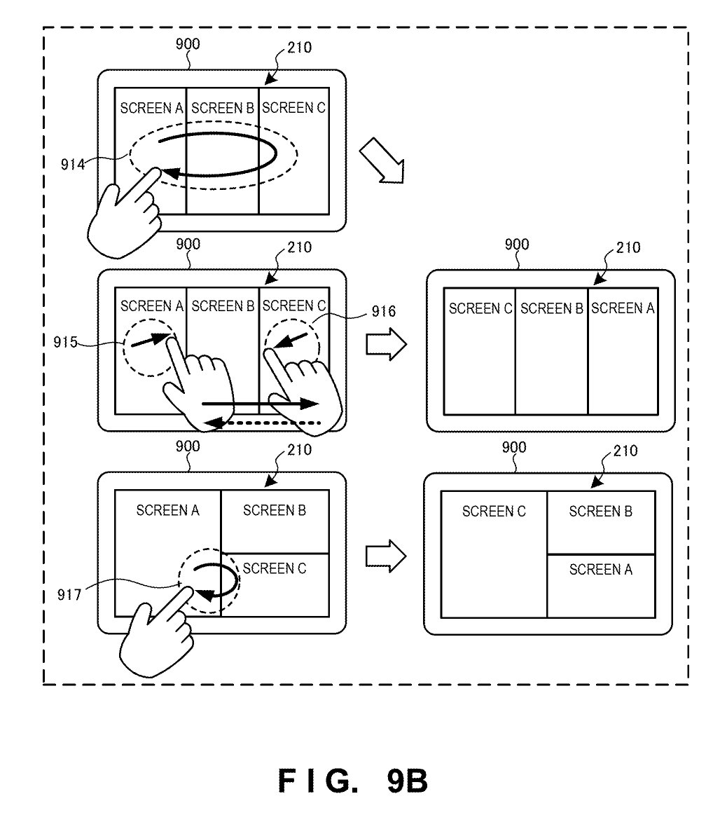

FIG. 9A is a view showing a screen exchange operation of an information processing apparatus 900 according to this embodiment. FIG. 9A shows an example in which two screens are divisionally displayed. FIG. 9A shows, from left, a screen exchange operation by one finger and a screen exchange result.

Screens A and B are divisionally displayed on a display screen 210 of the information processing apparatus 900. When the user draws a stroke 911 on screens A and B by one finger of the left hand (or one finger of the right hand), screens A and B are exchanged (see the right view). The stroke 911 includes a stroke from screen A to screen B and a stroke from screen B to screen A. Alternatively, when the user draws a stroke 912 toward screen B on screen A and a stroke 913 toward screen A on screen B by one finger of the left hand (or one finger of the right hand), screens A and B are exchanged (see the right view). This operation is an intuitive operation representing that the user is intended to exchange the screens. Therefore, it is possible to exchange the display positions by the operation directly representing the user's intention.

FIG. 9B is a view showing another screen exchange operation of the information processing apparatus 900 according to this embodiment. FIG. 9B shows an example in which three screens are divisionally displayed. FIG. 9B shows, from left, a screen exchange operation by one finger and a screen exchange result.

Screens A, B, and C are divisionally displayed on the display screen 210 of the information processing apparatus 900. When the user draws a stroke 914 on screens A, B, and C by one finger of the left hand (or one finger of the right hand), screens A and C are exchanged (see the upper right view). The stroke 914 includes a stroke from screen A to screen C and a stroke from screen C to screen A. Alternatively, when the user draws a stroke 915 toward screen C on screen A and a stroke 916 toward screen A on screen C by one finger of the left hand (or one finger of the right hand), screens A and C are exchanged (see the upper right view). In addition, when the user draws a stroke 917 on screens A and C by one finger of the left hand (or one finger of the right hand), screens A and C are exchanged (see the lower right view). The stroke 917 includes a stroke from screen A to screen C and a stroke from screen C to screen A. This operation is an intuitive operation representing that the user is intended to exchange the screens. Therefore, it is possible to exchange the display positions by the operation directly representing the user's intention.

(Exchange Determination Table)

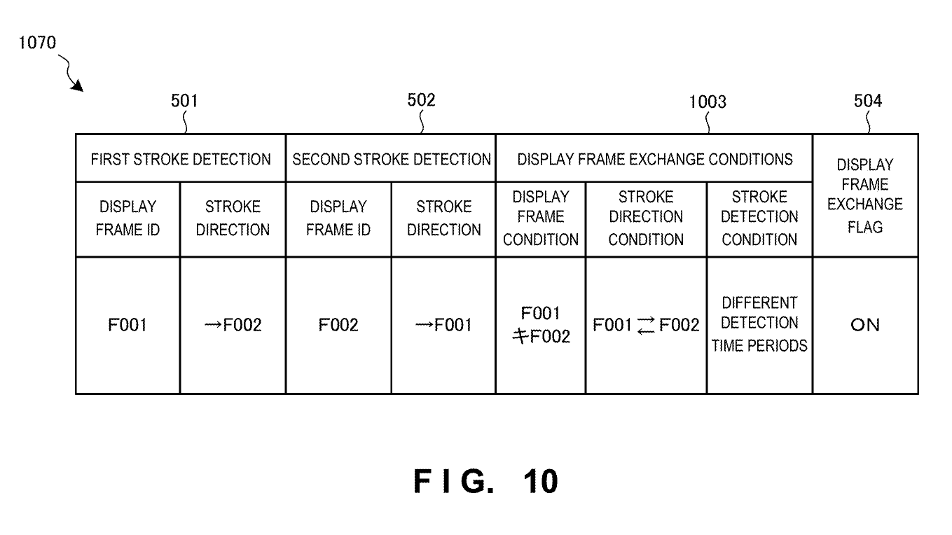

FIG. 10 is a table showing the structure of an exchange determination table 1070 according to this embodiment. The exchange determination table 1070 stores conditions for setting the display frame exchange flag to “1”, thereby determining that a screen exchange operation has been performed. FIG. 10 shows conditions for determining a screen exchange operation. Note that in FIG. 10, the same reference numerals as those in FIG. 5 denote the same components, and a description thereof will be omitted.

The exchange determination table 1070 stores conditions 1003 for determining a display frame exchange operation. The conditions 1003 include a display frame condition, a stroke direction condition, and a stroke detection condition. The display frame condition is a condition that detected first and second strokes are different. The stroke direction condition is a condition that each of the first and second strokes is oriented to the display frame of the exchange partner. The stroke detection condition is related to the relationship between the detection times of the first and second strokes. In this embodiment, the stroke detection condition is a condition that the time periods do not overlap each other, that is, the first and second strokes have different detection time periods. If the screen exchange operation according to this example is performed by one finger, these conditions are often satisfied. Alternatively, even if two fingers are used, these conditions may be satisfied.

If all the conditions 1003 are satisfied, a display frame exchange flag 504 is turned on (set to “1”) in the exchange determination table 1070.

FIG. 10 shows, as a practical example of the case of FIGS. 9A and 9B, a case in which the first stroke in a display frame F001 is oriented to a display frame F002, the second stroke in the display frame F002 is oriented to the display frame F001, and the first and second strokes have different time periods. Then, the display frame exchange flag 504 is turned on (set to “1”).

<<Processing Procedure of Information Processing Apparatus>>

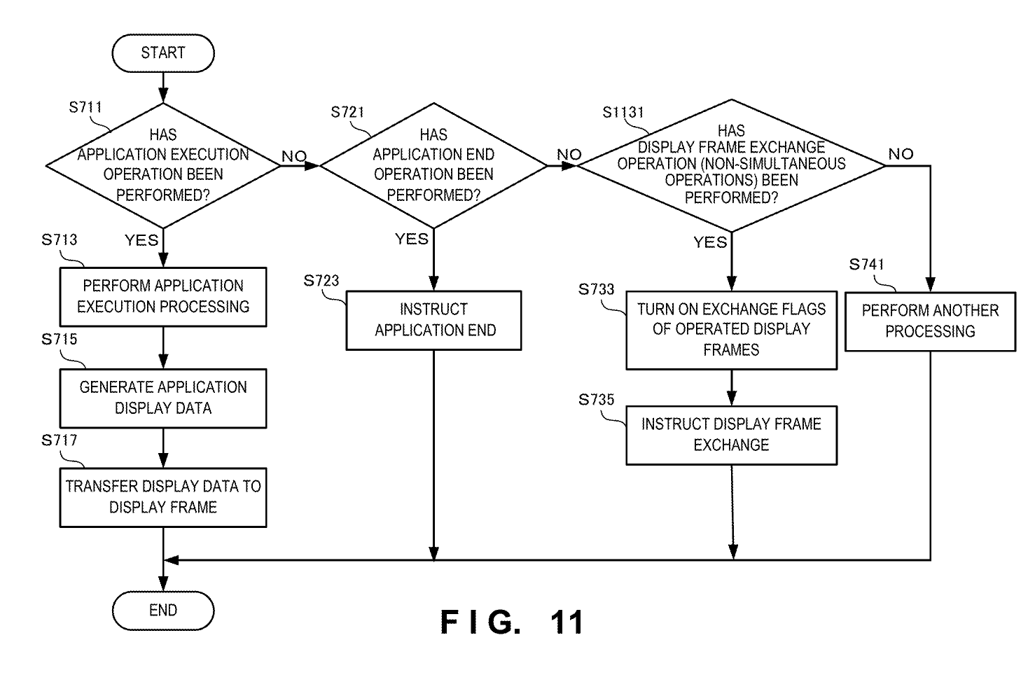

FIG. 11 is a flowchart illustrating the processing procedure of the information processing apparatus 900 according to this embodiment. This flowchart is executed by a CPU 610 of FIG. 6 using a RAM 640, thereby implementing the functional components of FIG. 3. Note that in FIG. 11, the same step numbers as those in FIG. 7 denote the same steps, and a description thereof will be omitted.

If neither an application execution operation nor an application end operation has been performed, the information processing apparatus 900 determines in step S1131 whether a screen exchange operation has been performed on the screen. In this example, non-simultaneous operations in which two strokes have different time periods correspond to the screen exchange operation. If it is determined that the screen exchange operation has been performed, the information processing apparatus 900 turns on, in step S733, the display frame exchange flags of the display frames for which the screen exchange operation has been performed, and instructs display frame exchange in step S735.

According to this embodiment, different screens are exchanged using one finger of one hand by detecting, in each of the regions of the different screens, a stroke toward the other screen. Thus, it is possible to exchange the display positions by the operation directly representing the user's intention.

### Fourth Embodiment

An information processing apparatus according to the fourth embodiment of the present invention will be described next. The information processing apparatus according to this embodiment is different from those according to the second and third embodiments in that the screens of the information processing apparatus are arranged in the vertical direction. The remaining components and operations are the same as those in the second and third embodiments. Hence, the same reference numerals denote the same components and operations, and a detailed description thereof will be omitted.

<<Screen Exchange Operation>>

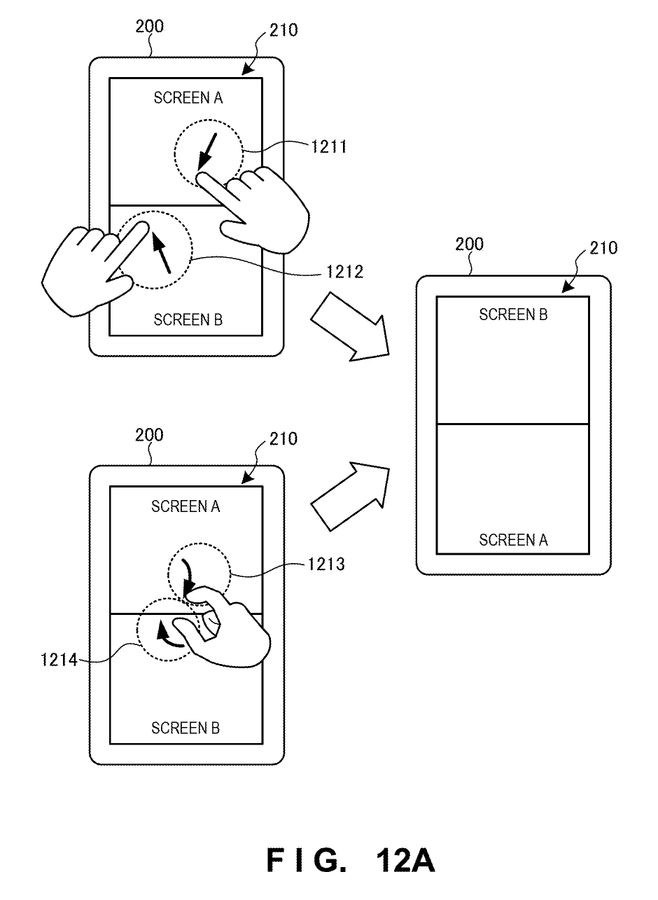

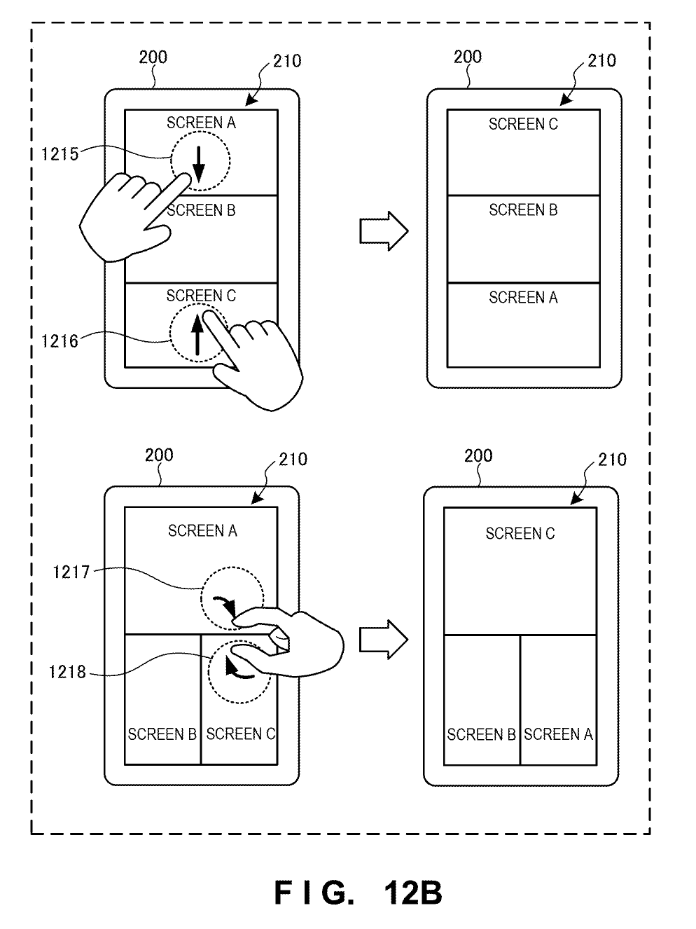

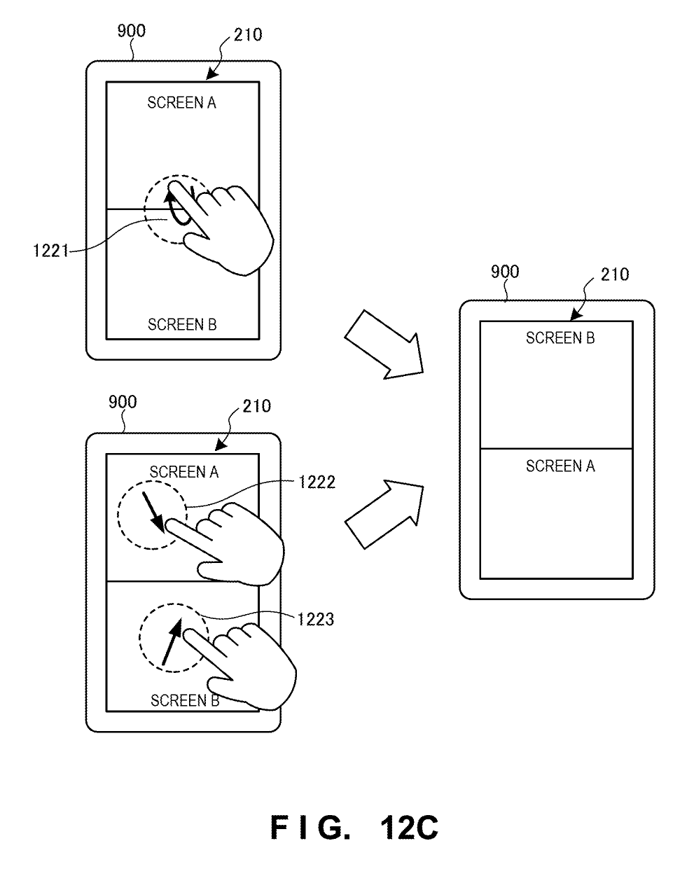

FIG. 12A is a view showing a screen exchange operation of an information processing apparatus 200 according to this embodiment. FIG. 12A shows an example in which two screens are divisionally displayed in the vertical direction. FIG. 12A shows, from left, a screen exchange operation by two fingers and a screen exchange result.

Screens A and B are divisionally displayed in the vertical direction on a display screen 210 of the information processing apparatus 200. When the user draws a stroke 1211 toward screen B on screen A by a finger of the left hand, and draws a stroke 1212 toward screen A on screen B by a finger of the right hand, screens A and B are exchanged (see the right view). Alternatively, when the user draws a stroke 1213 toward screen B on screen A and a stroke 1214 toward screen A on screen B by two fingers of the right hand (or two fingers of the left hand), screens A and B are exchanged (see the right view). This operation is an intuitive operation representing that the user is intended to exchange the screens. Therefore, it is possible to exchange the display positions by the operation directly representing the user's intention.

FIG. 12B is a view showing another screen exchange operation of the information processing apparatus 200 according to this embodiment. FIG. 12B shows an example in which three screens are divisionally displayed by including the vertical direction. FIG. 12B shows, from left, a screen exchange operation by two fingers and a screen exchange result.

Screens A, B, and C are divisionally displayed in the vertical direction on the display screen 210 of the information processing apparatus 200. When the user draws a stroke 1215 toward screen C on screen A by a finger of the left hand, and draws a stroke 1216 toward screen A on screen C by a finger of the right hand, screens A and C are exchanged (see the right view). Screens A, B, and C are divisionally displayed in the vertical and horizontal directions on the display screen 210 of the information processing apparatus 200. When the user draws a stroke 1213 toward screen C on screen A and a stroke 1214 toward screen A on screen C by two fingers of the right hand (or two fingers of the left hand), screens A and C are exchanged (see the right view). This operation is an intuitive operation representing that the user is intended to exchange the screens. Therefore, it is possible to exchange the display positions by the operation directly representing the user's intention.

FIG. 12C is a view showing still other screen exchange operation of an information processing apparatus 900 according to this embodiment. FIG. 12C shows an example in which two screens are divisionally displayed in the vertical direction. FIG. 12C shows, from left, a screen exchange operation by one finger and a screen exchange result.

Screens A and B are divisionally displayed on a display screen 210 of the information processing apparatus 900. When the user draws a stroke 1221 on screens A and B by one finger of the right hand (or one finger of the left hand), screens A and B are exchanged (see the right view). The stroke 1221 includes a stroke from screen A to screen B and a stroke from screen B to screen A. Alternatively, when the user draws a stroke 1222 toward screen B on screen A and a stroke 1223 toward screen A on screen B by one finger of the right hand (or one finger of the left hand), screens A and B are exchanged (see the right view). This operation is an intuitive operation representing that the user is intended to exchange the screens. Therefore, it is possible to exchange the display positions by the operation directly representing the user's intention.

According to this embodiment, even if the screens are arranged in the vertical direction, the screens are exchanged upon detecting, in each of the regions of the different screens, a stroke toward the other screen. Thus, it is possible to exchange the display positions by the operation directly representing the user's intention.

### Fifth Embodiment

An information processing apparatus according to the fifth embodiment of the present invention will be described next. The information processing apparatus according to this embodiment is different from those according to the second to fourth embodiments in that at least two screens are exchanged by rotation. The remaining components and operations are the same as those in the second to fourth embodiments. Hence, the same reference numerals denote the same components and operations, and a detailed description thereof will be omitted.

<<Screen Exchange Operation>>

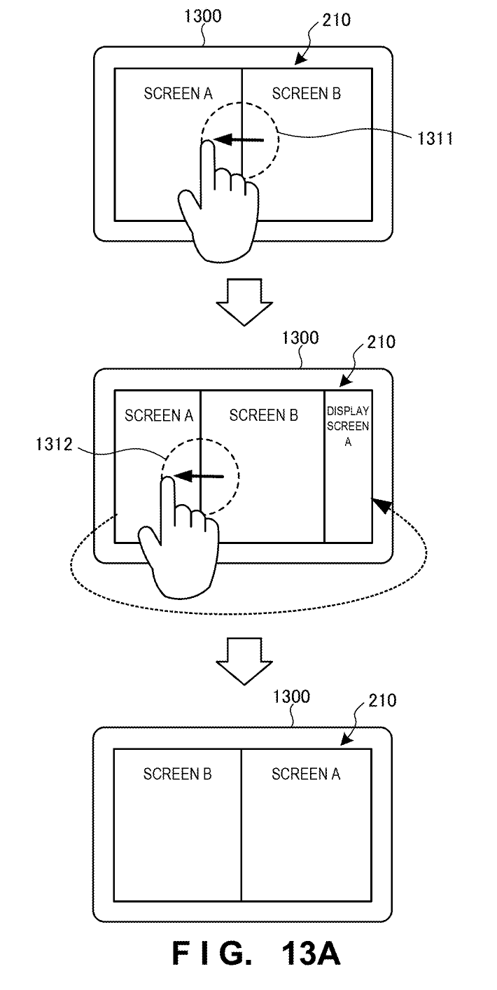

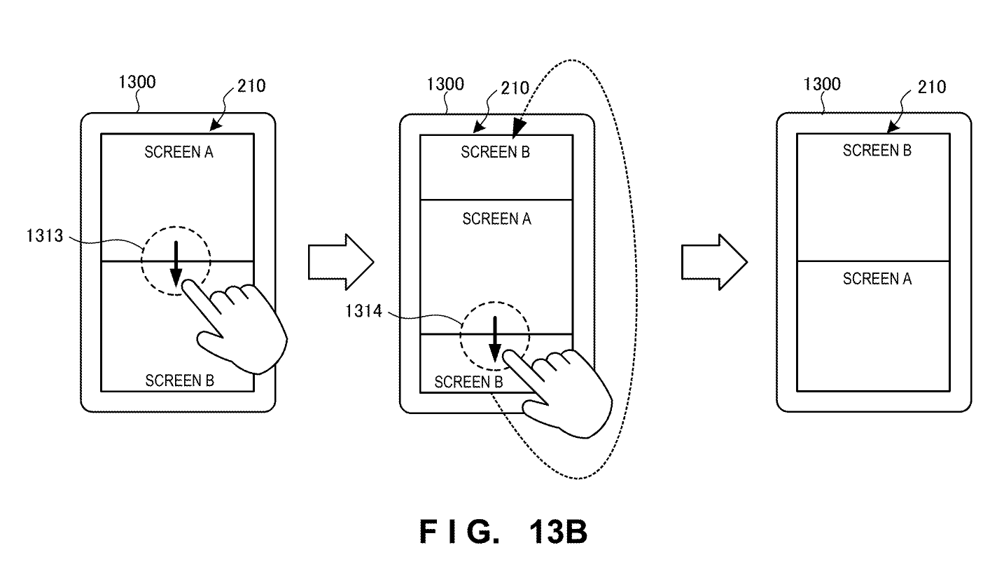

FIG. 13A is a view showing a screen exchange operation of an information processing apparatus 1300 according to this embodiment. FIG. 13A shows an example in which two screens are divisionally displayed in the horizontal direction. FIG. 13A shows, from above, the first screen rotation operation, an in-progress screen rotation operation, and a screen exchange result.

Screens A and B are divisionally displayed on a display screen 210 of the information processing apparatus 1300. When the user draws a stroke 1311 from screen A to screen B by a finger of the right hand (or a finger of the left hand), screens A and B are rotated and moved in the direction of the stroke 1311 (in this example, leftward) (see the central view). Furthermore, when the user draws a stroke 1312 from screen A to screen B by a finger of the right hand (or a finger of the left hand) in the rotated and moved state shown in the central view, screens A and B are further rotated and moved in the direction of the stroke 1312 (in this example, leftward), and are finally exchanged (see the lower view).

FIG. 13B is a view showing another screen exchange operation of the information processing apparatus 1300 according to this embodiment. FIG. 13B shows an example in which two screens are divisionally displayed in the vertical direction. FIG. 13B shows, from left, the first screen rotation operation, an in-progress screen rotation operation, and a screen exchange result.

Screens A and B are divisionally displayed on the display screen 210 of the information processing apparatus 1300. When the user draws a stroke 1313 from screen A to screen B by a finger of the right hand (or a finger of the left hand), screens A and B are rotated and moved in the direction of the stroke 1313 (in this example, downward) (see the central view). When the user draws a stroke 1314 from screen A to screen B by a finger of the right hand (or a finger of the left hand) in the rotated and moved state shown in the central view, screens A and B are further rotated and moved in the direction of the stroke 1314 (in this example, downward), and are finally exchanged (see the lower view).

Note that a stroke according to this embodiment is desirably drawn by a flick operation like a light flip by a fingertip but may be drawn by a swipe operation of sliding a fingertip.

<<Functional Arrangement of Information Processing Apparatus>>

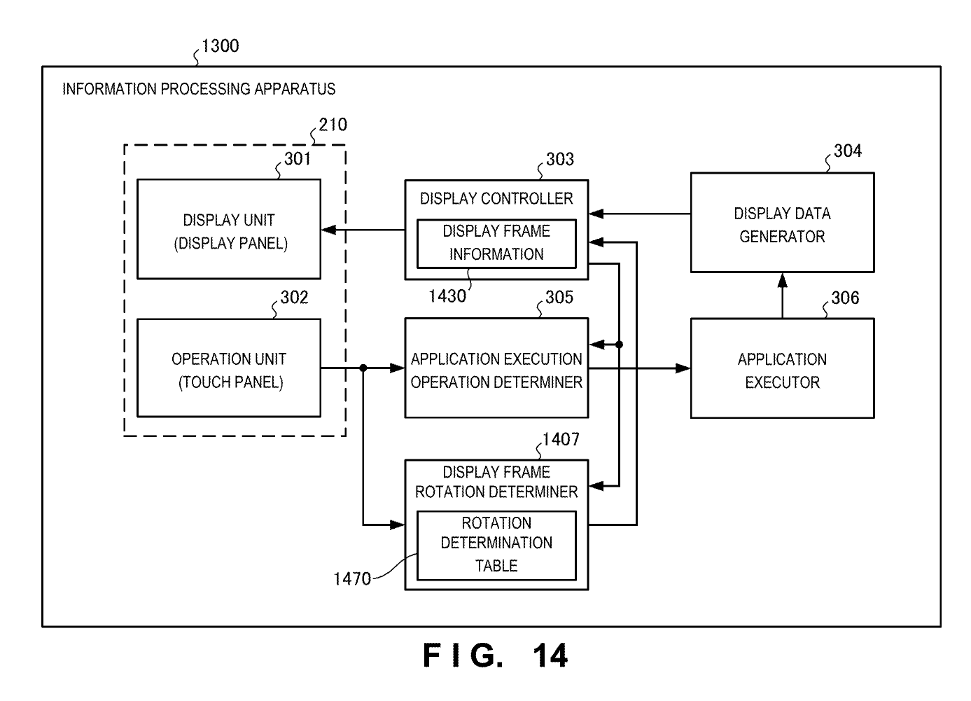

FIG. 14 is a block diagram showing the functional arrangement of the information processing apparatus 1300 according to this embodiment. Note that in FIG. 14, the same reference numerals as those in FIG. 3 denote the same functional components, and a description thereof will be omitted.

The information processing apparatus 1300 includes a display controller 1403. The display controller 1403 has display frame information 1430, assigns, to a display frame, display data generated by executing an application, and displays the display data on a display unit 301, thereby implementing screen control.

Furthermore, the information processing apparatus 1300 includes a display frame rotation determiner 1407. The display frame rotation determiner 1407 has a rotation determination table 1470, and determines screen rotation based on an operation in the operation unit 302. If the display frame rotation determiner 1407 determines screen rotation, the display controller 1403 rotates screens by changing the display frame information 1430, thereby finally implementing screen exchange.

(Display Frame Information)

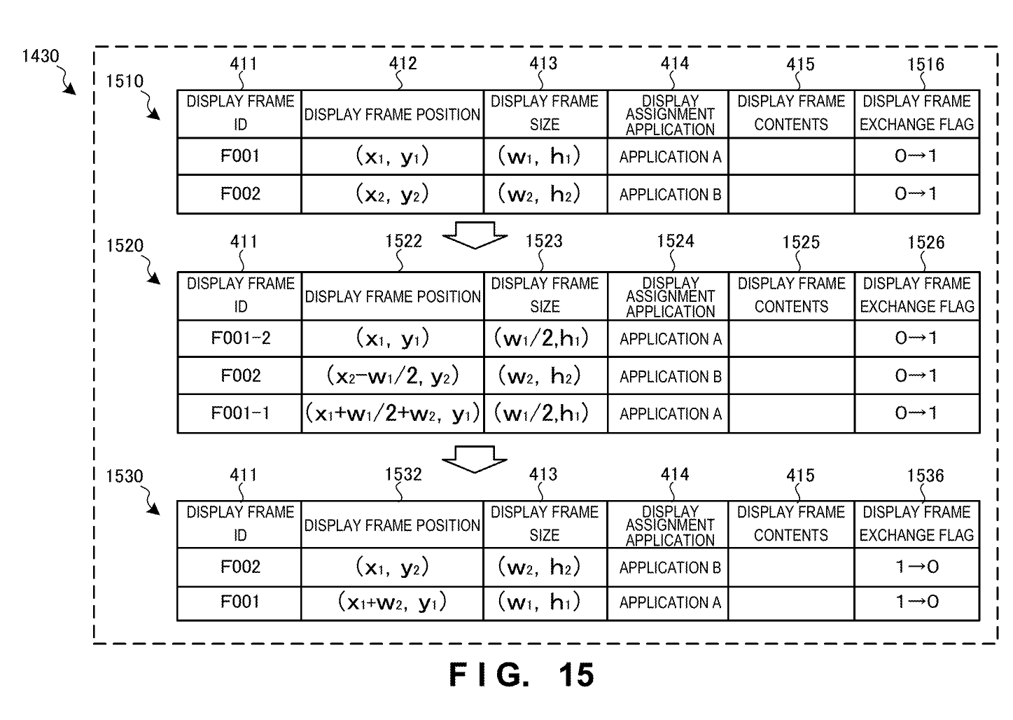

FIG. 15 is a view showing the structure of the display frame information 1430 according to this embodiment. The display frame information 1430 is used by the display controller 1403 to arrange display information related to an application on a screen. FIG. 15 shows an example of exchange by rotating, in the horizontal direction in FIG. 13A, screen A generated by application A and screen B generated by application B. Note that in FIG. 15, for each display frame, different numerical values are set also in a frame display position and frame size in the y-axis direction (vertical direction) in order to maintain the generality. However, in the case of the divided screens in the x-axis direction (horizontal direction) shown in FIG. 13A, the same values of y and h are set for all display frames. Note that in FIG. 15, the same reference numerals as those in FIG. 4 denote the same components, and a description thereof will be omitted.

The upper part of FIG. 15 shows display frame information 1510 before exchange (before rotation). The display frame information 1510 stores, for each display frame, a display frame rotation flag 1516 based on a screen rotation operation. In this example, by the screen rotation operation, the display frame rotation flags 1516 change from “0” to “1”, thereby executing screen rotation.

The middle part of FIG. 15 shows display frame information 1520 during rotation. In this example, data in a state in which screen A is rotated a half-turn are shown. In the display frame information 1520, screen A displayed on two sides of the display screen 210 are represented by two display frames F001-1 and F001-2. The display frame information 1520 stores a display frame position 1522 and a display frame size 1523 during rotation in association with each display frame ID 411.

The display frame information 1520 stores, in association with the display frame ID 411, as a display assignment application 1524, an application for generating information to be displayed on the display frame. Frame contents 1525 generated by the application are stored. The display frame information 1520 stores, for each display frame, a display frame rotation flag 1526 based on the screen rotation operation. In this example, by the screen rotation operation, the display frame rotation flags 1526 change from “0” to “1”, thereby executing screen rotation.

The lower part of FIG. 15 shows display frame information 1530 after exchange. The display frame information 1530 stores a display frame position 1532 and a display frame size 413 after screen exchange in association with the display frame ID 411.

The display frame information 1530 stores, for each display frame, a display frame rotation flag 1536 based on the screen exchange operation. In this example, upon end of the screen exchange operation, the display frame rotation flags 1536 change from “1” to “0”, thereby ending screen exchange by screen rotation.

(Rotation Determination Table)

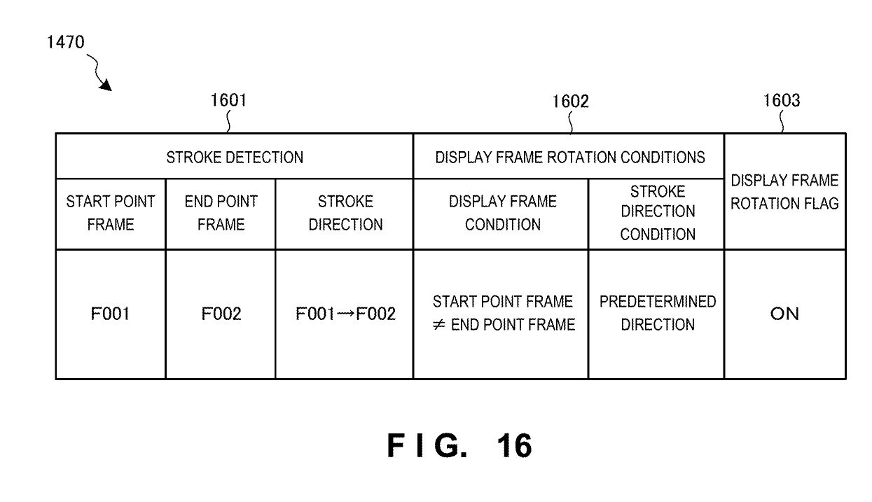

FIG. 16 is a table showing the structure of the rotation determination table 1470 according to this embodiment. The rotation determination table 1470 stores conditions for setting the display frame rotation flag to “1”, thereby determining that a screen rotation operation has been performed. FIG. 16 shows conditions for determining a screen rotation operation.

The rotation determination table 1470 stores stroke detection 1601 including the viewpoint frame, end point frame, and stroke direction of a stroke detected on the screen. The rotation determination table 1470 stores conditions 1602 for determining a display frame rotation operation. The conditions 1602 include a display frame condition and a stroke direction condition. The display frame condition is a condition that the start point frame and end point frame of the detected stroke are different. The stroke direction condition is a condition that the detected stroke is oriented in a predetermined direction.

If all the conditions 1602 are satisfied, a display frame rotation flag 1603 is turned on (set to “1”) in the rotation determination table 1470.

FIG. 16 shows, as a practical example of the case of FIGS. 13A and 13B, a case in which the detected stroke has a start point in a display frame F001 and an end point in a display frame F002, and is oriented from the display frame F001 to the display frame F002. Then, the display frame rotation flag 1603 is turned on (set to “1”).

Note that the condition, of the conditions 1602, that the start point frame and end point frame are different is not essential.

<<Processing Procedure of Information Processing Apparatus>>

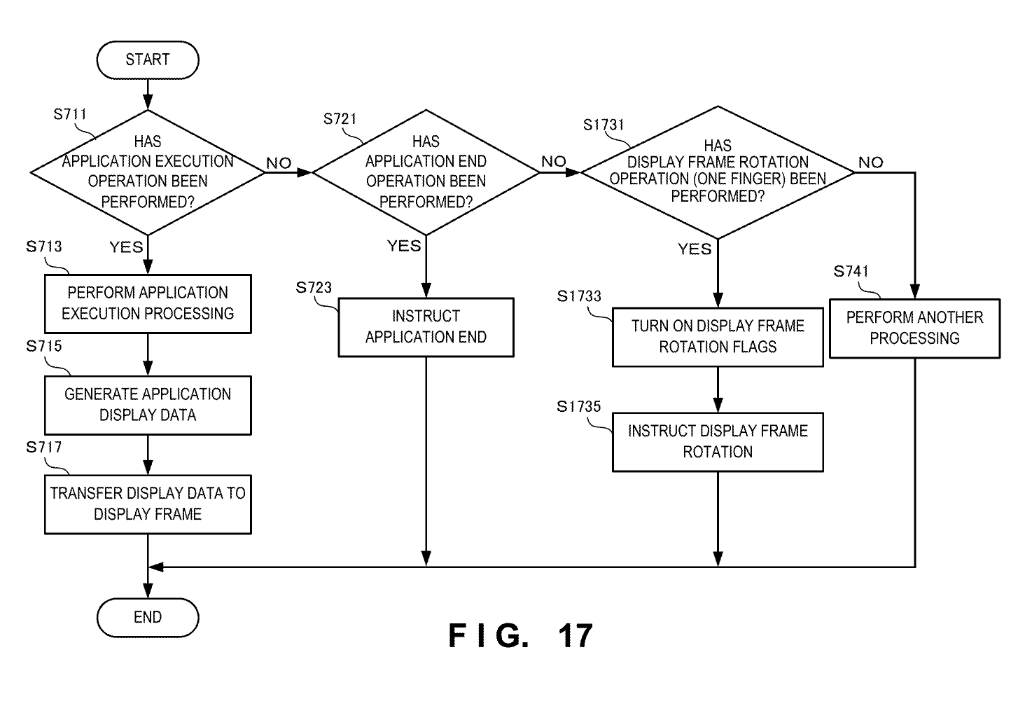

FIG. 17 is a flowchart illustrating the processing procedure of the information processing apparatus 1300 according to this embodiment. This flowchart is executed by a CPU 610 of FIG. 6 using a RAM 640, thereby implementing the functional components of FIG. 3. Note that in FIG. 17, the same step numbers as those in FIG. 7 denote the same steps, and a description thereof will be omitted.

If neither an application execution operation nor an application end operation has been performed, the information processing apparatus 1300 determines in step S1731 whether a screen rotation operation has been performed on the screen. If it is determined that the screen rotation operation has been performed, the information processing apparatus 1300 turns on the display frame rotation flags in step S1733, and instructs display frame rotation in step S1735.

(Display Frame Control)

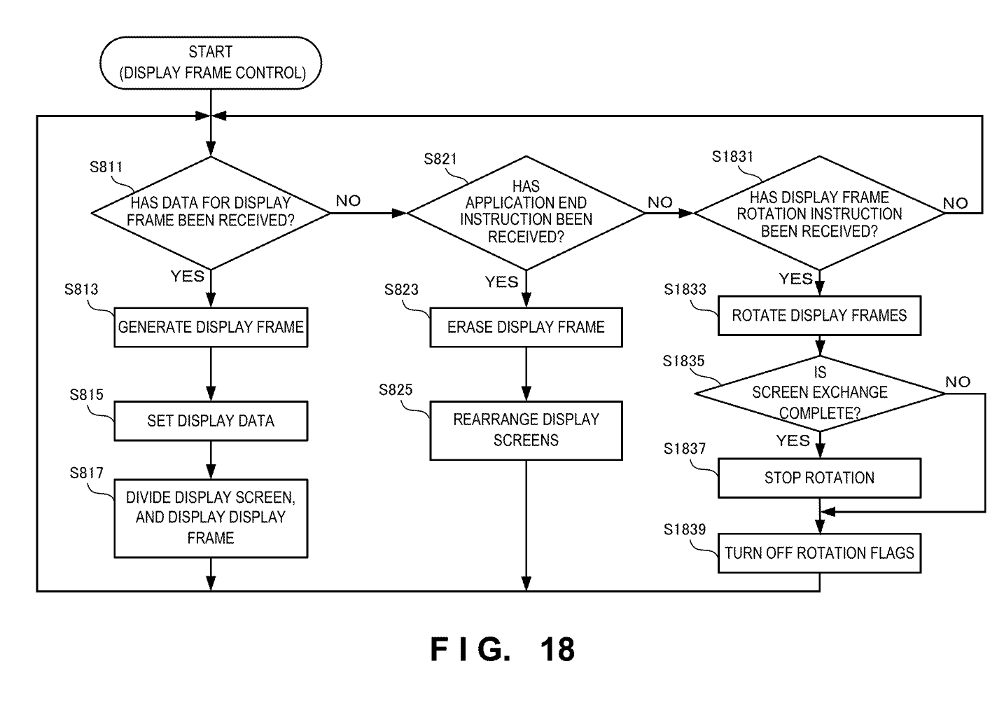

FIG. 18 is a flowchart illustrating a display frame control procedure according to this embodiment. Note that in FIG. 18, the same step numbers as those in FIG. 8 denote the same steps, and a description thereof will be omitted.

If neither data for a display frame nor an application end instruction has been received, the information processing apparatus 1300 determines in step S1831 whether a screen rotation instruction has been received by the processing in step S1735 of FIG. 17. If the screen rotation instruction has been received, the information processing apparatus 1300 executes, in step S1833, processing of rotating the display frames each having the display frame rotation flag “ON”. In step S1835, the information processing apparatus 1300 determines whether screen exchange is complete during rotation. This determination processing can be performed based on the positions or rotation amounts of the display frames or zero of the size of the original display frame F001-2 in the example of FIG. 15. If screen exchange is complete during rotation, the information processing apparatus 1300 stops rotation in step S1837. In step S1839, the information processing apparatus 1300 turns off the display frame rotation flags, thereby ending the screen rotation processing.

According to this embodiment, upon detecting a stroke for rotating screens, the screens can be exchanged. Thus, it is possible to exchange the display positions by the operation directly representing the user's intention.

### Sixth Embodiment

An information processing apparatus according to the sixth embodiment of the present invention will be described next. The information processing apparatus according to this embodiment is different from those according to the second to fifth embodiments in that at least two screens are superimposed and displayed. The remaining components and operations are the same as those in the second to fifth embodiments. Hence, the same reference numerals denote the same components and operations, and a detailed description thereof will be omitted.

<<Screen Exchange Operation>>

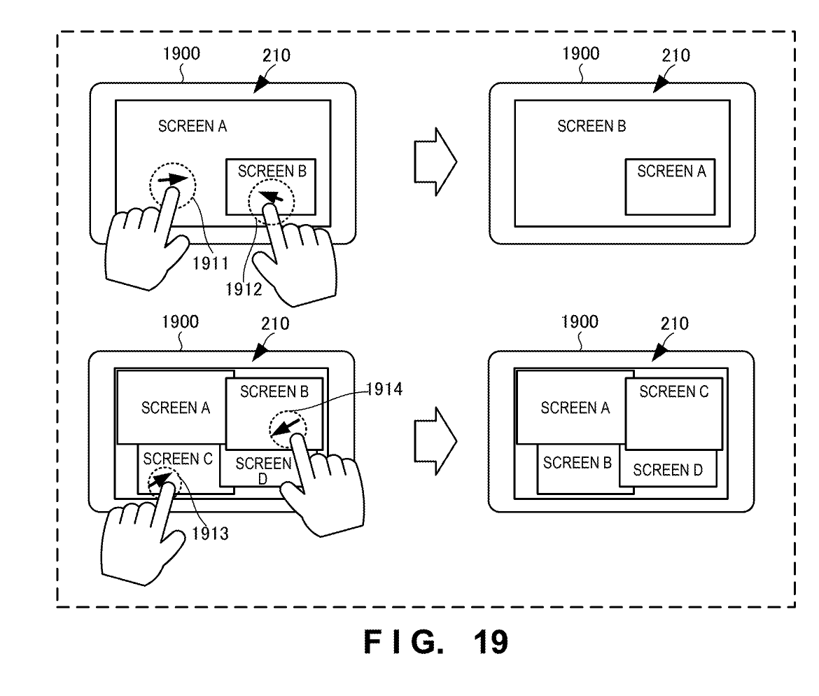

FIG. 19 is a view showing a screen exchange operation of an information processing apparatus 1900 according to this embodiment. FIG. 19 shows an example in which screens are superimposed and displayed. FIG. 19 shows, from left, a screen exchange operation by two fingers and a screen exchange result.

In the upper part of FIG. 19, screen B is superimposed and displayed on a screen A on a display screen 210 of the information processing apparatus 1900. When the user draws a stroke 1911 toward screen B on screen A by a finger of the left hand, and draws a stroke 1912 toward screen A on screen B by a finger of the right hand, screens A and B are exchanged.

In the lower part of FIG. 19, screens B, A, D, and C are superimposed and displayed on the display screen 210 of the information processing apparatus 1900 in the order named from above. When the user draws a stroke 1913 toward screen B on screen C by a finger of the left hand, and draws a stroke 1914 toward screen C on screen B by a finger of the right hand, screens C and B are exchanged.

According to this embodiment, even if screens are superimposed and displayed, if, in each of the regions of different screens, a stroke toward the other screen is detected, the screens are exchanged. Thus, it is possible to exchange the display positions by the operation directly representing the user's intention.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present invention is applicable to a system including a plurality of devices or a single apparatus. The present invention is also applicable even when a control program for implementing the functions of the embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described embodiments.

This application claims the benefit of Japanese Patent Application No. 2014-188303 filed on Sep. 16, 2014, which is hereby incorporated by reference herein in its entirety.

1. An information processing apparatus comprising:
a display unit that displays at least two screens;
a stroke detector that detects, in regions of different screens, strokes toward another screen; and
an exchanger that exchanges the different screens if said stroke detector detects the strokes.

2. The information processing apparatus according to claim 1, wherein if said stroke detector detects the strokes in the regions of the different screens during a common time period, said exchanger exchanges the different screens.

3. The information processing apparatus according to claim 1, wherein if said stroke detector detects the strokes in the regions of the different screens during different time periods, said exchanger exchanges the different screens.

4. The information processing apparatus according to claim 1, wherein if touches within a first time period are detected in the regions of the different screens, said stroke detector starts detection of the strokes.

5. The information processing apparatus according to claim 1, wherein if a stroke is started within a second time period after touch at a start position, said stroke detector starts detection of the stroke.

6. A method of controlling an information processing apparatus, comprising:
displaying at least two screens;
detecting, in regions of different screens, strokes toward another screen; and
exchanging the different screens if the strokes are detected in the detecting step.

7. A non-transitory computer-readable storage medium storing a program of controlling an information processing apparatus, for causing a computer to execute a method, comprising:
displaying at least two screens;
detecting, in regions of different screens, strokes toward another screen; and
exchanging the different screens if the strokes are detected in the detecting step.

8. A method of exchanging multi-screen display position, comprising:
detecting, in regions of different screens, strokes toward another screen; and
exchanging the different screens if the strokes are detected in the detecting step.

9. The information processing apparatus according to claim 2, wherein if touches within a first time period are detected in the regions of the different screens, said stroke detector starts detection of the strokes.

10. The information processing apparatus according to claim 2, wherein if a stroke is started within a second time period after touch at a start position, said stroke detector starts detection of the stroke.

11. The information processing apparatus according to claim 3, wherein if touches within a first time period are detected in the regions of the different screens, said stroke detector starts detection of the strokes.

12. The information processing apparatus according to claim 3, wherein if a stroke is started within a second time period after touch at a start position, said stroke detector starts detection of the stroke.

13. The information processing apparatus according to claim 4, wherein if a stroke is started within a second time period after touch at a start position, said stroke detector starts detection of the stroke.
